(19) United States
(12) Patent Application Publication
(10) Pub. No.: US 2018/0046895 A1
(43) Pub. Date: Feb. 15, 2018

(54) DEVICE AND METHOD FOR IMPLEMENTING A SPARSE NEURAL NETWORK

(71) Applicant: Deephi Technology Co., Ltd., Beijing (CN)

(72) Inventors: Dongliang XIE, Beijing (CN); Junlong KANG, Beijing (CN); Song HAN, Beijing (CN)

(21) Appl. No.: 15/242,625

(22) Filed: Aug. 22, 2016

(30) Foreign Application Priority Data
Aug. 12, 2016 (CN) 201610663175.X

(51) Int. Cl. G06N 3/04; G06N 3/08

(52) U.S. Cl. CPC G06N 3/04; G06N 3/082

(57) ABSTRACT

The present invention proposes a highly parallel solution for implementing ANN by sharing both weights matrix of ANN and input activation vectors. It significantly reduces the memory access operations, the on-chip buffers. In addition, the present invention considers how to achieve a load balance among a plurality of on-chip processing units being operated in parallel. It also considers a balance between the I/O bandwidth and calculation capabilities of the processing units.

### CROSS REFERENCE TO RELATED APPLICATIONS

This application claims priority to Chinese Patent Application Number 201610663175.X filed on Aug. 12, 2016, the entire content of which is incorporated herein by reference.

### TECHNICAL FIELD

The present application aims to provide a device and method for accelerating the implementation of a neural network, so as to improve the efficiency of neural network operations.

### BACKGROUND

Artificial neural networks (ANN), also called NNs, is a distributed information processing model which absorbs the animals' neural network behavior characteristics. In recent years, study of ANN achieved fast developments and it has great potentials to be applied in various areas, such as image recognition, voice recognition, natural language processing, weather forecasting, gene techniques, contents pushing, etc.

FIG. 1 shows a simplified neuron being activated by a plurality of activation inputs. The accumulated activation received by the neuron shown in FIG. 1 is the sum of weighted inputs from other neurons (not shown). Xⱼ represents the accumulated activation of the neuron in FIG. 1 Yi represents an activation input from another neuron, represents the weight of said activation input from a neuron, wherein:

Xⱼ=(y₁*W₁)+(y₂*W₂)− . . . +(yᵢ*Wᵢ)+ . . . +(yₙ*Wₙ) (1)

After receiving the input of the accumulated activation Xⱼ, the neuron will further give activation input to surrounding neurons, which is represented by yⱼ:

yⱼ=f(Xⱼ) (2)

said neuron outputs activation yⱼ after receiving and processing the accumulated input activation Xⱼ, wherein f( ) is called a activation function.

Also, in recent years, the scale of ANNs is exploding. Large DNN models are very powerful but consume large amounts of energy because the model must be stored in external DRAM, and fetched every time for each image, word, or speech sample. For embedded mobile applications, these resource demands become prohibitive. One advanced ANN model might have billions of connections and the implementation thereof is both calculation-centric and memory-centric.

In the prior art, it typically uses a CPU or GPU (graphic processing unit) to implement an ANN. However, it is not clear how much potential can be further developed in the processing capabilities of conventional chips, as Moore's Law might stop being valid one day. Thus, it is critically important to compress an ANN model into a smaller scale.

Previous work have used specialized hardware to accelerate DNNs. However, these work are focusing on accelerating dense, uncompressed models—limiting its utility to small models or to cases where the high energy cost of external DRAM access can be tolerated. Without model compression, it is only possible to fit very small neural networks, such as Lenet-5, in on-chip SRAM.

Since memory access is the bottleneck in large layers, compressing the neural network comes as a solution. Model compression might change a large ANN model into a sparse ANN model, which reduces both calculations and memory complexity.

However, though compression reduces the total amount of ops, the irregular pattern caused by compression hinders the effective acceleration on CPUs and GPUs. CPU or GPU cannot fully exploit benefits of a sparse ANN model. The acceleration achieved by conventional CPU or CPU in quite limited in implementing a sparse ANN model.

It is desirable that a compressed matrix like sparse matrix stored in CCS format can be computed efficiently with specific circuits. It motivates building of an engine that can operate on a compressed network. It is desired to have a novel and efficient solution for accelerating implementation of a sparse ANN model.

### SUMMARY

According to one aspect of the present invention, it proposes a device for implementing a neural network, comprising: an receiving unit for receiving a plurality of input vectors a₁, a₁, . . . ; a sparse matrix reading unit, for reading a sparse weight matrix W of said neural network, said matrix W represents weights of a layer of said neural network; a plurality of processing elements PE_{xy}, wherein x=0,1, . . . M-1, y=0,1, . . . N-1, such that said plurality of PE are divided into M groups of PE, and each group has N PE, x represents the x^{th} group of PE, y represents the y^{th} PE of the group PE; a control unit being configured to input a number of M input vectors aᵢ to said M groups of PE, and input a fraction Wₚ of said matrix W to the j^{th} PE of each group of PE, wherein j=0,1, . . . N-1; each of said PE perform calculations on the received input vector and the received fraction Wₚ of the matrix W, and an outputting unit for outputting the sum of said calculation results to output a plurality of output vectors b₀, b₁, . . . .

According to one aspect of the present invention, said control unit is configured to input a number of M input vectors aᵢ to said M groups of PE, wherein i is chosen as follows: i (MOD M)=0,1, . . . M-1.

According to one aspect of the present invention, said control unit is configured to input a fraction Wₚ of said matrix W to the j^{th} PE of each group of PE, wherein j=0,1, . . . N-1, wherein Wₚ is chosen from p^{th} rows of W in the following manner: p (MOD N)=j, wherein p=0,1, . . . P-1, j=0,1, . . . N-1, said matrix W is of the size P*Q.

According to another aspect of the present invention, it proposes a method for implementing a neural network, comprising: receiving a plurality of input vectors a₀, a₁, . . . ; reading a sparse weight matrix W of said neural network, said matrix W represents weights of a layer of said neural network; inputting said input vectors and matrix W to a plurality of processing elements PE_{xy}, wherein x=0,1, . . . M-1, y=0,1, . . . N-1, such that said plurality of PE are divided into M groups of PE, and each group has N PE, x represents the x^{th} group of PE, y represents the y^{th} PE of the group PE, said inputting step comprising: inputting a number of M input vectors aᵢ to said M groups of PE; inputting a fraction Wₚ of said matrix W to the j^{th} PE of each group of PE, wherein j=0,1, . . . N-1; performing calculations on the received input vector and the received fraction Wₚ of the matrix W by each of said PE; outputting the sum of said calculation results to output a plurality of output vectors b₀, b₁, . . . .

According to another aspect of the present invention, the step of inputting a number of M input vectors a, to said M groups of PE comprising: choosing i as follows: i (MOD M)=0,1, . . . M-1.

According to another aspect of the present invention, the step of inputting a fraction Wₚ of said matrix W to the j^{th} PE of each group of PE, wherein j=0,1, . . . N-1, further comprising: choosing p^{th} rows of W as Wₚ in the following manner: p (MOD N)=j, wherein p =0,1, . . . P-1, j=0,1, . . . N-1, said matrix W is of the size P*Q.

With the above proposed method and device, the present invention proposes a highly parallel solution for implementing ANN by sharing both weights matrix of ANN and input activation vectors. It significantly reduces the memory access operations, the on-chip buffers.

In addition, the present invention considers how to achieve a load balance among a plurality of on-chip processing units being operated in parallel. It also considers a balance between the I/O bandwidth and calculation capabilities of the processing units.

### BRIEF DESCRIPTION OF THE DRAWINGS

FIG. 1 shows the accumulation and input of a neuron.

FIG. 2 shows an Efficient Inference Engine (EIE) used for a compressed deep neural network (DNN) in machine learning.

FIG. 3 shows how weight matrix W and input vectors a, b are distributed among four processing units (PE).

FIG. 4 shows how weight matrix W is compressed as CCS format, corresponding to one PE of FIG. 3.

FIG. 5 shows a more detailed structure of the encoder shown in FIG. 2.

FIG. 6 shows a proposed hardware structure for implementing a sparse ANN according to one embodiment of the present invention.

FIG. 7 shows a simplified structure of the proposed hardware structure of FIG. 6 according to one embodiment of the present invention.

FIG. 8 shows one specific example of FIG. 6 with four processing units according to one embodiment of the present invention.

FIG. 9 shows one specific example of weight matrix W and input vectors according to one embodiment of the present invention on the basis of the example of FIG. 8.

FIG. 10 shows how the weight matrix W is stored as CCS format according to one embodiment of the present invention on the basis of the example of FIG. 8.

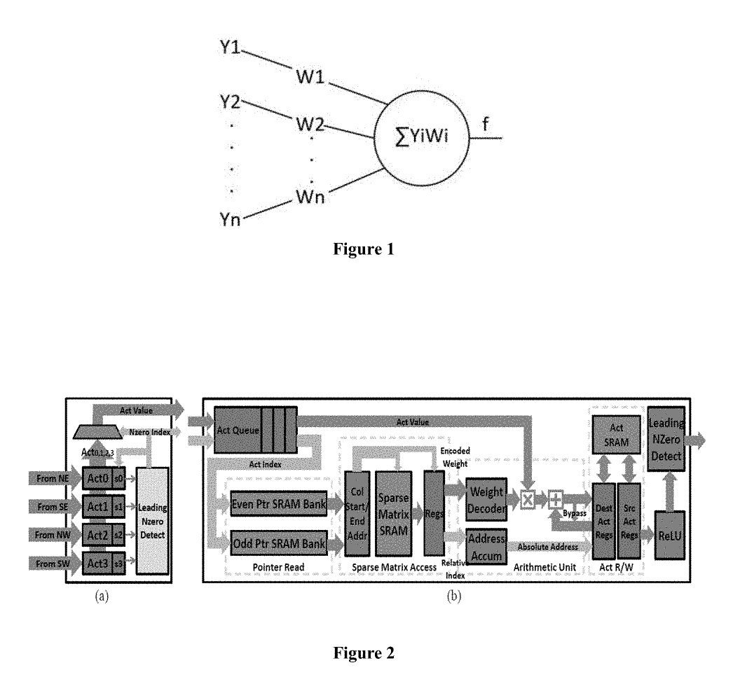

### EMBODIMENTS

DNN Compression and Parallelization

A FC layer of a DNN performs the computation

b=f(Wa+v) (3)

Where a is the input activation vector, b is the output activation vector, v is the bias, W is the weight matrix, and f is the non-linear function, typically the Rectified Linear Unit (ReLU) in CNN and some RNN. Sometimes v will be combined with W by appending an additional one to vector a, therefore we neglect the bias in the following paragraphs.

For a typical FC layer like FC7 of VGG-16 or AlexNet, the activation vectors are 4K long, and the weight matrix is 4K×4K (16M weights). Weights are represented as single precision floating-point numbers so such a layer requires 64 MB of storage. The output activations of Equation (3) is computed element-wise as:

bᵢ=ReLU(Σⱼ₌₀ⁿ⁻¹Wᵢⱼaⱼ) (4)

Song Han, Co-inventor of the present application, once proposed a deep compression solution in “Deep compression: Compressing deep neural networks with pruning, trained quantization and Huffman coding”, which describes a method to compress DNNs without loss of accuracy through a combination of pruning and weight sharing. Pruning makes matrix W sparse with density D ranging from 4% to 25% for our benchmark layers. Weight sharing replaces each weight Wᵢⱼ with a four-bit index Iᵢⱼ into a shared table S of 16 possible weight values.

With deep compression, the per-activation computation of Equation (4) becomes

bᵢ=ReLU(Σ_{j∈X}_{ᵢ}_{∩Y}S[Iᵢⱼ]aⱼ) (5)

Where Xᵢ is the set of columns j for which Wᵢⱼ≠0, Y is the set of indices j for which aj≠0, Iᵢⱼ is the index to the shared weight that replaces Wi j, and S is the table of shared weights.

Here Xᵢ represents the static sparsity of W and Y represents the dynamic sparsity of a. The set Xᵢ is fixed for a given model. The set Y varies from input to input.

Accelerating Equation (5) is needed to accelerate compressed DNN. By performing the indexing S[Iᵢⱼ] and the multiply add only for those columns for which both Wᵢⱼ and aⱼ are non-zero, both the sparsity of the matrix and the vector are exploited. This results in a dynamically irregular computation. Performing the indexing itself involves bit manipulations to extract four-bit Iᵢⱼ and an extra load.

CRS and CCS Representation.

For a sparse matrix, it is desired to compress the matrix in order to reduce the memory requirements. It has been proposed to store sparse matrix by Compressed Row Storage (CRS) or Compressed Column Storage (CCS).

In the present application, in order to exploit the sparsity of activations, we store our encoded sparse weight matrix W in a variation of compressed column storage (CCS) format.

For each column Wj of matrix W, it stores a vector v that contains the non-zero weights, and a second, equal-length vector z that encodes the number of zeros before the corresponding entry in v. Each entry of v and z is represented by a four-bit value. If more than 15 zeros appear before a non-zero entry we add a zero in vector v. For example, it encodes the following column

[0,0,1,2,0,0,0,0,0,0,0,0,0,0,0,0,0,0,0,0,0,0,3].

As v=[1,2,0,3], z=[2,0,15,2]. v and z of all columns are stored in one large pair of arrays with a pointer vector p pointing to the beginning of the vector for each column. A final entry in p points one beyond the last vector element so that the number of non-zeros in column j (including padded zeros) is given by pⱼ₊₁−pⱼ.

Storing the sparse matrix by columns in CCS format makes it easy to exploit activation sparsity. It simply multiplies each non-zero activation by all of the non-zero elements in its corresponding column.

For further details regarding the storage of a sparse matrix, please refer to U.S. Pat. No. 9,317,482, UNIVERSAL FPGA/ASIC MATRIX-VECTOR MULTIPLICATION ARCHITECTURE. In this patent, it proposes a hardware-optimized sparse matrix representation referred to herein as the Compressed Variable Length Bit Vector (CVBV) format, which is used to take advantage of the capabilities of FPGAs and reduce storage and band width requirements across the matrices compared to that typically achieved when using the Compressed Sparse Row format in typical CPU- and GPU-based approaches. Also, it discloses a class of sparse matrix formats that are better suited for FPGA implementations than existing formats reducing storage and bandwidth requirements. A partitioned CVBV format is described to enable parallel decoding.

EIE: Efficient Inference Engine on Compressed Deep Neural Network

One of the co-inventors of the present invention has proposed and disclosed an Efficient Inference Engine (EIE). For a better understanding of the present invention, the EIE solution is briefly introduced here.

FIG. 2 shows the architecture of Efficient Inference Engine (EIE).

A Central Control Unit (CCU) controls an array of PEs that each computes one slice of the compressed network. The CCU also receives non-zero input activations from a distributed leading nonzero detection network and broadcasts these to the PEs.

Almost all computation in EIE is local to the PEs except for the collection of non-zero input activations that are broadcast to all PEs. However, the timing of the activation collection and broadcast is non-critical as most PEs take many cycles to consume each input activation.

Activation Queue and Load Balancing. Non-zero elements of the input activation vector aⱼ and their corresponding index j are broadcast by the CCU to an activation queue in each PE. The broadcast is disabled if any PE has a full queue. At any point in time each PE processes the activation at the head of its queue.

The activation queue allows each PE to build up a backlog of work to even out load imbalance that may arise because the number of non-zeros in a given column j may vary from PE to PE.

Pointer Read Unit. The index j of the entry at the head of the activation queue is used to look up the start and end pointers pⱼ and pⱼ₊₁ for the v and x arrays for column j. To allow both pointers to be read in one cycle using single-ported SRAM arrays, we store pointers in two SRAM banks and use the LSB of the address to select between banks. pⱼ and pⱼ₊₁ will always be in different banks. EIE pointers are 16-bits in length.

Sparse Matrix Read Unit. The sparse-matrix read unit uses pointers pⱼ and pⱼ₊₁ to read the non-zero elements (if any) of this PE's slice of column from the sparse-matrix SRAM. Each entry in the SRAM is 8-bits in length and contains one 4-bit element of v and one 4-bit element of x.

For efficiency the PE's slice of encoded sparse matrix I is stored in a 64-bit-wide SRAM. Thus eight entries are fetched on each SRAM read. The high 13 bits of the current pointer p selects an SRAM row, and the low 3-bits select one of the eight entries in that row. A single (v, x) entry is provided to the arithmetic unit each cycle.

Arithmetic Unit. The arithmetic unit receives a (v, x) entry from the sparse matrix read unit and performs the multiply accumulate operation bₓ=bₓ+v×aⱼ. Index x is used to index an accumulator array (the destination activation registers) while v is multiplied by the activation value at the head of the activation queue. Because v is stored in 4-bit encoded form, it is first expanded to a 16-bit fixed-point number via a table look up. A bypass path is provided to route the output of the adder to its input if the same accumulator is selected on two adjacent cycles.

Activation Read/Write. The Activation Read/Write Unit contains two activation register files that accommodate the source and destination activation values respectively during a single round of FC layer computation. The source and destination register files exchange their role for next layer. Thus no additional data transfer is needed to support multilayer feed-forward computation.

Each activation register file holds 64 16-bit activations. This is sufficient to accommodate 4K activation vectors across 64 PEs. Longer activation vectors can be accommodated with the 2 KB activation SRAM. When the activation vector has a length greater than 4K, the M×V will be completed in several batches, where each batch is of length 4K or less. All the local reduction is done in the register, and SRAM is read only at the beginning and written at the end of the batch.

Distributed Leading Non-Zero Detection. Input activations are hierarchically distributed to each PE. To take advantage of the input vector sparsity, we use leading non-zero detection logic to select the first positive result. Each group of 4 PEs does a local leading non-zero detection on input activation. The result is sent to a Leading Non-Zero Detection Node (LNZD Node) illustrated in FIG. 2. Four of LNZD Nodes find the next non-zero activation and sends the result up the LNZD Node quadtree. That way the wiring would not increase as we add PEs. At the root LNZD Node, the positive activation is broadcast back to all the PEs via a separate wire placed in an H-tree.

Central Control Unit. The Central Control Unit (CCU) is the root LNZD Node. It communicates with the master such as CPU and monitors the state of every PE by setting the control registers. There are two modes in the Central Unit: I/O and Computing.

In the I/O mode, all of the PEs are idle while the activations and weights in every PE can be accessed by a DMA connected with the Central Unit.

In the Computing mode, the CCU will keep collecting and sending the values from source activation banks in sequential order until the input length is exceeded. By setting the input length and starting address of pointer array, EIE will be instructed to execute different layers.

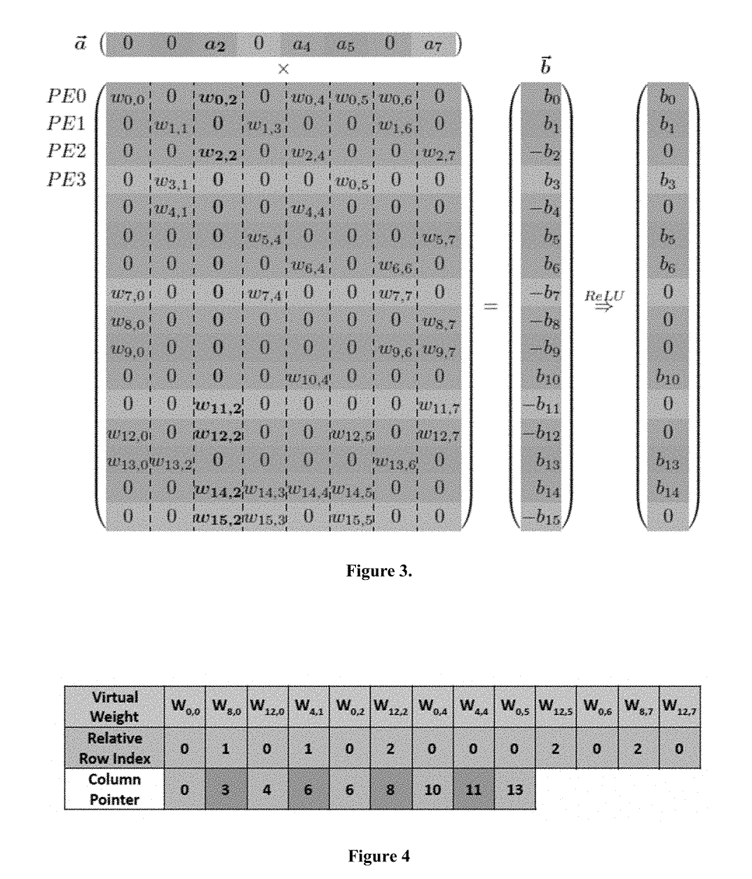

FIG. 3 shows how to distribute the matrix and parallelize our matrix-vector computation by interleaving the rows of the matrix W over multiple processing elements (PEs).

With N PEs, PEₖ holds all rows Wᵢ, output activations bi, and input activations aᵢ for which i (mod N)=k. The portion of column Wⱼ in PEₖ is stored in the CCS format described in Section 3.2 but with the zero counts referring only to zeros in the subset of the column in this PE. Each PE has its own v, x, and p arrays that encode its fraction of the sparse matrix.

In FIG. 3, it shows an example multiplying an input activation vector a (of length 8) by a 16×8 weight matrix W yielding an output activation vector b (of length 16) on N=4 PEs. The elements of a, b, and W are color coded with their PE assignments. Each PE owns 4 rows of W, 2 elements of a, and 4 elements of b.

It performs the sparse matrix x sparse vector operation by scanning vector a to find its next non-zero value aⱼ and broadcasting aⱼ along with its index j to all PEs. Each PE then multiplies aⱼ by the non-zero elements in its portion of column Wⱼ—accumulating the partial sums in accumulators for each element of the output activation vector b. In the CCS representation these non-zeros weights are stored contiguously so each PE simply walks through its v array from location pⱼ to pⱼ₊₁−1 to load the weights. To address the output accumulators, the row number i corresponding to each weight Wᵢⱼ is generated by keeping a running sum of the entries of the x array.

In the example of FIG. 3, the first non-zero is a₂ on PE₂. The value a₂ and its column index 2 is broadcast to all PEs. Each PE then multiplies a₂ by every non-zero in its portion of column 2. PE₀ multiplies a₂ by W_{0,2} and W_{12,2}; PE₁ has all zeros in column 2 and so performs no multiplications; PE₂ multiplies a₂ by W_{2,2} and W_{14,2}, and so on. The result of each dot product is summed into the corresponding row accumulator. For example PEₒ computes b₀=b₀+W_{0,2} a₂ and b₁₂=b₁₂+W_{12,2} a₂. The accumulators are initialized to zero before each layer computation.

The interleaved CCS representation facilitates exploitation of both the dynamic sparsity of activation vector a and the static sparsity of the weight matrix W.

It exploits activation sparsity by broadcasting only non-zero elements of input activation a. Columns corresponding to zeros in vector a are completely skipped. The interleaved CCS representation allows each PE to quickly find the non-zeros in each column to be multiplied by aⱼ. This organization also keeps all of the computation except for the broadcast of the input activations local to a PE.

The interleaved CCS representation of matrix in FIG. 3 is shown in FIG. 4.

FIG. 4 shows memory layout for the relative indexed, indirect weighted and interleaved CCS format, corresponding to PE0 in FIG. 3.

The relative row index: it indicates the number of zero-value weights between the present non-zero weight and the previous non-zero weight.

The column pointer: the value by the present column pointer reducing the previous column pointer indicates the number of non-zero weights in this column.

Thus, by referring to the index and pointer of FIG. 4, the non-zero weights can be accessed in the following manner: First, reading two consecutive column pointers and obtain the reduction value, said reduction value is the number of non-zero weights in this column. Next, by referring to the row index, the row address of said non-zero weights can be obtained. In this way, both the row address and column address of a non-zero weight can be obtained.

In FIG. 4, the weights have been further encoded as virtual weights. In order to obtain the real weights, it is necessary to decode the virtual weights.

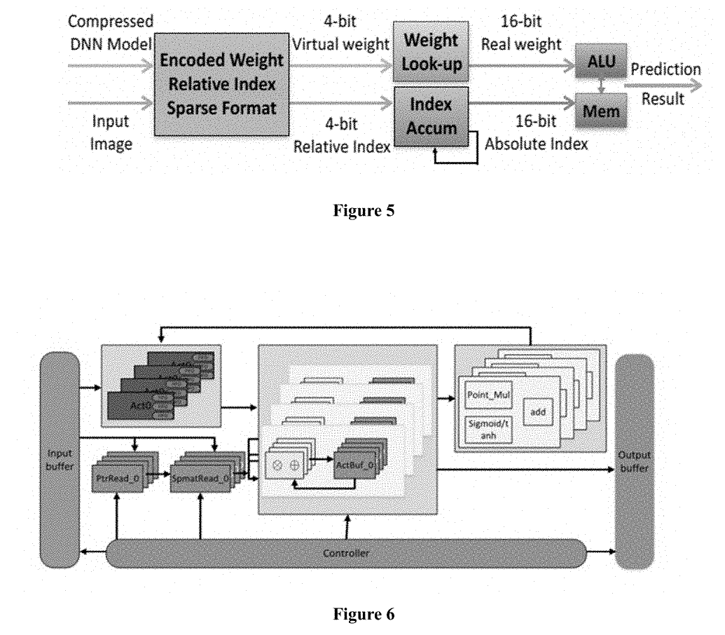

FIG. 5 shows more details of the weight decoder of the EIE solution shown in FIG. 2.

In FIG. 5, weight look-up and index Accum are used, corresponding to the weight decoder of FIG. 2. By using said index, weight look-up, and a codebook, it decodes a 4-bit virtual weight to a 16-bit real weight.

With weight sharing, it is possible to store only a short (4-bit) index for each weight. Thus, in such a solution, the compressed DNN is indexed with a codebook to exploit its sparsity. It will be decoded from virtual weights to real weights before it is implemented in the proposed EIE hardware structure.

The Proposed Improvement Over EIE

As the scale of neural networks becoming larger, it is more and more common to use many processing elements for parallel computing. In certain applications, the weight matrix has the size of 2048*1024, and the input vector has 1024 elements. In such a case, the computation complexity is 2048*1024*1024. It requires hundreds of, or even thousands of PEs.

With the previously EIE solution, it has the following problems in implementing an ANN with a lot of PEs.

First, the number of pointer vector reading units (e.g., Even Ptr SRAM Bank and Odd Ptr SRAM Bank in FIG. 2) will increase with the number of PEs. For example, if there are 1024 PEs, it will require 1024*2=2048 pointer reading units in EIE.

Secondly, as the number of PEs becomes large, the codebooks used for decoding virtual weights to real weights also increase. If there are 1024 PEs, it requires 1024 codebooks too.

The above problems become more challenging when the number of PEs increases. In particular, the pointer reading units and codebook are implemented in SRAM, which is valuable on-chip sources. Accordingly, the present application aims to solve the above problems in EIE.

In EIE solution, only input vectors (to be more specific, non-zero values in input vectors) are broadcasted to PEs to achieve parallel computing.

In the present application, it broadcasts both input vectors and matrix W to groups of PEs, so as to achieve parallel computing in two dimensions.

FIG. 6 shows a chip hardware design for implementing an ANN according to one embodiment of the present application.

As shown in FIG. 6, the chip comprises the following units.

Input activation queue (Act) is provided for receiving a plurality of input activation, such as a plurality of input vectors a0, a1, . . . .

According to one embodiment of the present application, said input activation queue further comprises a plurality of FIFO (first in first out) units, each of which corresponds to a group of PE.

A plurality of processing elements PE_{xy} (ArithmUnit), wherein x=0,1, . . . M-1, y=0,1, . . . N-1, such that said plurality of PE are divided into M groups of PE, and each group has N PE, x represents the x^{th} group of PE, y represents the y^{th} PE of the group PE.

A plurality of pointer reading units (Ptrread) are provided to read pointer information (or, address information) of a stored weight matrix W, and output said pointer information to a sparse matrix reading unit.

A plurality of sparse matrix reading units (SpmatRead) are provided to read non-zero values of a sparse matrix W of said neural network, said matrix W represents weights of a layer of said neural network.

According to one embodiment of the present application, said sparse matrix reading unit further comprises: a decoding unit for decoding the encoded matrix W so as to obtain non-zero weights of said matrix W. For example, it decodes the weights by index and codebook, as shown in FIGS. 2 and 5.

A control unit (not shown in FIG. 6) is configured to schedule all the PEs to perform parallel computing.

Assuming there are 256 PEs, which are divided as M groups of PE, and each group having N PEs. Assuming M=8, N=32, each PE can be represented as PE_{xy}, wherein x=0,1, . . . 7, and y=0,1, . . . 31.

The control unit schedules the input activation queue to input 8 vectors to 8 group of PEs each time, wherein the input vectors can be represented by a0, a1, . . . a7.

The control unit also schedules the plurality of sparse matrix reading units to input a fraction Wₚ of said matrix W to the j^{th} PE of each group of PE, wherein j=0,1, . . . 31. In one embodiment, assuming the matrix W has a size of 1024*512, the Wₚ is chosen from p^{th} rows of the matrix W, wherein p (MOD 32)=j.

This manner of choosing Wp has the advantages of balancing workloads for a plurality of PEs. In a sparse matrix W, the non-zero values are not evenly distributed. Thus different PEs might get different workloads of calculation which will results in un-balanced workloads. By choosing Wp out of W in an interleaved manner, it helps to even workloads assigned to different PEs.

In addition, there are other dividing manners for 256 PEs. For example, it can divide them into 4*64, which receives 4 input vectors once. Or, 2*128, which receives 2 input vectors once.

In summary, the control unit schedules input activation queue to input a number of M input vectors aᵢ to said M groups of PE. In addition, it schedules said plurality of sparse matrix reading units to input a fraction Wₚ of said matrix W to the j^{th} PE of each group of PE, wherein j=0,1, . . . N-1.

Each of said PE perform calculations on the received input vector and the received fraction Wₚ of the matrix W.

Lastly, as shown in FIG. 6, an output buffer (ActBuf) is provided for outputting the sum of said calculation results. For example, the output buffer outputs a plurality of output vectors b1, b2, . . . .

According to one embodiment of the present application, said output buffer further comprises: a first buffer and a second buffer, which are used to receive and output calculation results of said PE in an alternative manner, so that one of the buffers receives the present calculation result while the other of the buffers outputting the previous calculation result.

In one embodiment, said two buffers accommodate the source and destination activation values respectively during a single round of ANN layer (i.e., weight matrix W) computation. The first and second buffers exchange their role for next layer. Thus no additional data transfer is needed to support multilayer feed-forward computation.

According to one embodiment of the present application, the proposed chip for ANN further comprises a leading zero detecting unit (not shown in FIG. 6) used for detecting non-zero values in input vectors and output said non-zero values to the Input activation queue.

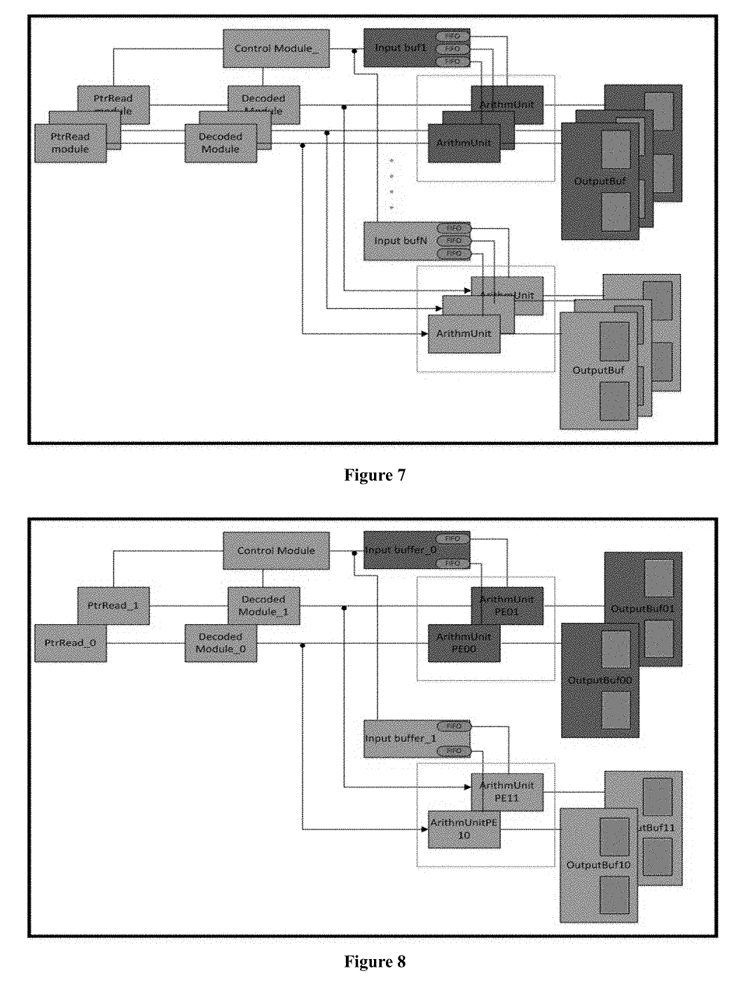

FIG. 7 shows a simplified diagram of the hardware structure of FIG. 6.

In FIG. 7, the location module corresponds to the pointer reading unit (PtrRead) of FIG. 6, the decoding module corresponds to the sparse matrix reading unit (SpmatRead) of FIG. 6, the processing elements corresponds to the processing elements (ArithmUnit) of FIG. 6, and the output buffer corresponds to the ActBuf of FIG. 6.

With the solution shown in FIGS. 6 and 7, it broadcasts both the input vectors and the matrix W, which exploit both the sparsity of input vectors and the sparsity of matrix W. It significantly reduce the memory access operations, and also reduces the number of on-chip buffers.

In addition, it saves SRAM spaces. For example, assuming there are 1024 PEs, the proposed solution may divide them as 32*32, with 32 PE as a group to perform a matrix*vector (W*X), and it only requires 32 location modules and 32 decoding units. The location modules and decoding units will not increase in proportion to the number of PEs.

For another example, assuming there are 1024 PEs, the proposed solution may divide them as 16*64, with 64 PE as a group to perform a matrix*vector (W*X), and it only requires 16 location modules and 16 decoding units. The location modules and decoding units will be shared by 64 matrix*vector (W*X) operations.

The above arrangements of 32*32 and 16*64 differ from each other in that the first one performs 32 PE calculations at the same time, while the latter one performs 64 PE calculations at the same time. The extents of parallel computing are different, and the time delay are different too. The optimal arrangement is decided on the basis of actual needs, I/O bandwidth, on-chip resources, etc.

### EXAMPLE 1

To further clarify the invention, it gives a simple example. Here we uses a weight matrix of 8*8, an input vector x has 8 elements, and 4 (2*2) PEs.

Two PEs are a group of PE to perform one matrix*vector operation, and 4 PEs are able to process two input vectors at one time. The matrix W is stored as CCS format.

FIG. 8 shows the hardware design for the above example of 4 PEs.

Location module 0 (pointer) is used to store column pointers of odd row non-zero values, wherein P(j+1)−P(j) represents the number of non-zero values in column j.

Decoding module 0 is used to store non-zero weight values in odd rows and the relative row index. If the weights are encoded, the decoding module will decode the weights.

The odd row elements in matrix W (stored in decoding module 0) will be broadcasted to two PE₀₀ and PE₁₀. The even row elements in matrix W (stored in decoding module 1) will be broadcasted to two PE₀₁ and PE₁₁. In FIG. 8, it computes two input vectors at one time, such as Y₀=W*X₀ and Y₁=W*X₁.

Input buffer 0 is used to store input vector X0.

In addition, in order to compensate the different sparsity distributed to different PEs, it provides FIFO to store input vectors before sending these input vectors to PEs.

The control module is used to schedule and control other modules, such as PEs, location modules, decoding modules, etc.

PE₀₀ is used to perform multiplication between odd row elements of matrix W and input vector X₀ and the accumulation thereof.

Output buffer₀₀ is used to store intermediate results and the odd elements of final outcome Y₀.

In a similar manner, FIG. 8 provides location module 1, decoding module 1, PE₀₁, output buffer ₀₁ to computer the even elements of final outcome Y₀.

Location module 0, decoding module 0, PE₁₀, output buffer ₁₀ are used to computer the odd elements of final outcome Y₁.

Location module 1, decoding module 1, PE₁₁, output buffer ₁₁ are used to computer the even elements of final outcome Y₁.

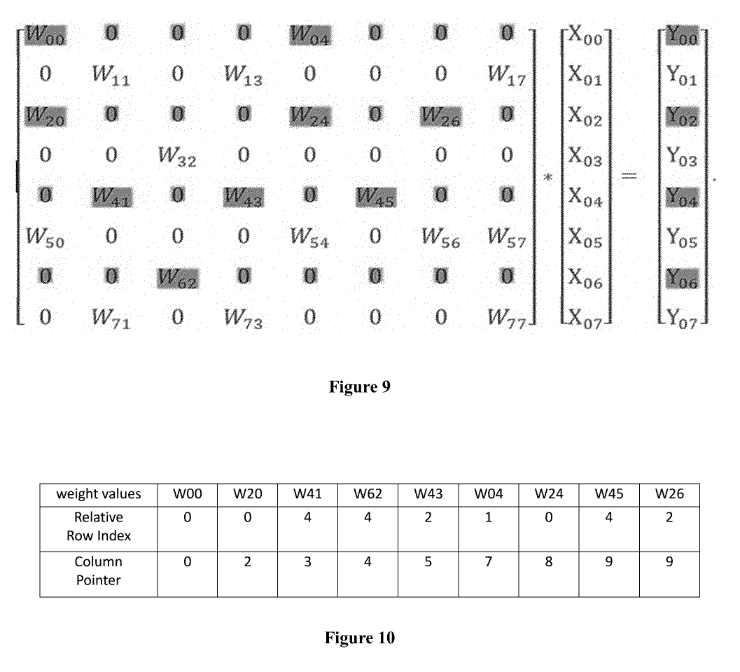

FIG. 9 shows how to compute the matrix W and input vector a on the basis of the hardware design of FIG. 8.

As shown in FIG. 9, odd row elements are calculated by PEₓ₀, odd row elements are calculated by PEₓ₁. Odd elements of the result vector are calculated by PEₓ₀, and even elements of the result vector are calculated by PEₓ₁.

Specifically, in W*X₀, PE₀₀ performs odd row elements of W*X₀. PE₀₁ performs even row elements of W*X₀. PE₀₀ outputs odd elements of Y₀. PE₀₁ outputs even elements of Y₀.

In W*X₁, PE₁₀ performs odd row elements of W*X₁. PE₁₁ performs even row elements of W*X₁. PE₁₀ outputs odd elements of Y₁. PE₁₁ outputs even elements of Y₁.

In the above solution, input vector X₀ is broadcasted to PE₀₀ and PE₀₁. Input vector X₁ is broadcasted to PE₁₀ and PE₁₁.

The odd row elements in matrix W (stored in decoding module 0) will be broadcasted to two PE₀₀ and PE₁₀. The even row elements in matrix W (stored in decoding module 1) will be broadcasted to two PE₀₁ and PE₁₁.

The division of matrix W is described earlier with respect to FIG. 6.

FIG. 10 shows how to store a part of weight W, said part of weight corresponds to PE₀₀ and PE₁₀.

The relative row index=the number of zero-value weights between the present non-zero weight and the previous non-zero weight.

The column pointer: The present column pointer−the previous column pointer=the number of non-zero weights in this column.

Thus, by referring to the index and pointer of FIG. 10, the non-zero weights can be accessed in the following manner. First, reading two consecutive column pointers and obtain the reduction value, said reduction value is the number of non-zero weights in this column. Next, by referring to the row index, the row address of said non-zero weights can be obtained. In this way, both the row address and column address of a non-zero weight can be obtained.

According to one embodiment of the present invention, the column pointer in FIG. 10 is stored in location module 0, and both the relative row index and the weight values are stored in decoding module 0.

Performance Comparison

In the proposed invention, the location modules and decoding modules will not increase in proportion to the number of PE. For example, in the above propose example 1, there are 4 PEs, two location modules and two decoding modules shared by PEs. If adopting the EIE solution, it will need 4 decoding modules and 4 location modules.

In sum, the present invention makes the following contributions:

It presents an ANN accelerator for sparse and weight sharing neural networks. It solves the deficiency in conventional CPU and GPU in implementing sparse ANN by broadcasting both input vectors and matrix W.

In addition, it proposes a method of both distributed storage and distributed computation to parallelize a sparsified layer across multiple PEs, which achieves load balance and good scalability.

What is claimed is:

1. A device for implementing an artificial neural network, comprising:
an receiving unit for receiving a plurality of input vectors a₀, a₁, . . . ;
a sparse matrix reading unit, for reading a sparse weight matrix W of said neural network, said matrix W represents weights of a layer of said neural network;
a plurality of processing elements PE_{xy}, wherein x=0,1, . . . M-1, y=0,1, . . . N-1, such that said plurality of PE are divided into M groups of PE, and each group has N PE, x represents the x^{th} group of PE, y represents the y^{th} PE of the group PE,
a control unit being configured to
input a plurality of input vectors aᵢ to said M groups of PE,
input a fraction Wₚ of said matrix W to the j^{th} PE of each group of PE, wherein j=0,1, . . . N-1,
each of said PEs perform calculations on the received input vector and the received fraction Wₚ of the matrix W,
an outputting unit for outputting the sum of said calculation results to output a plurality of output vectors b₀, b₁, . . . .

2. The device of claim 1, said control unit is configured to input M input vectors aᵢ to said M groups of PE,
wherein i is chosen as follows: i (MOD M)=0,1, . . . M-1.

3. The device of claim 1, said control unit is configured to input a fraction Wₚ of said matrix W to the j^{th} PE of each group of PE, wherein j=0,1, . . . N-1,
wherein Wₚ is chosen from p^{th} rows of W in the following manner: p (MOD N)=j, wherein p=0,1, . . . P-1, j=0,1, . . . N-1, said matrix W is of the size P*Q.

4. The device of claim 1, wherein the matrix W is compressed with CCS (compressed column storage) or CRS (compressed row storage) format.

5. The device of claim 1, said matrix W is encoded with an index and codebook.

6. The device of claim 4, said sparse matrix reading unit further comprises:
a pointer reading unit for reading address information in order to access non-zero weights of said matrix W.

7. The device of claim 5, said sparse matrix reading unit further comprises:
a decoding unit for decoding the encoded matrix W so as to obtain non-zero weights of said matrix W.

8. The device of claim 1, further comprising:
a leading zero detecting unit for detecting non-zero values in input vectors and output said non-zero values to the receiving unit.

9. The device of claim 1, wherein said receiving unit further comprising:
a plurality of FIFO (first in first out) units, each of which corresponding to a group of PE.

10. The device of claim 1, said output unit further comprising:
a first buffer and a second buffer, which are used to receive and output calculation results of said PE in an alternative manner, so that one of the buffers receives the present calculation result while the other of the buffers outputs the previous calculation result.

11. A method for implementing an artificial neural network, comprising:
receiving a plurality of input vectors a₀, a₁, . . . ;
reading a sparse weight matrix W of said neural network, said matrix W represents weights of a layer of said neural network;
inputting said input vectors and matrix W to a plurality of processing elements PE_{xy}, wherein x=0,1, . . . M-1, y=0,1, . . . N-1, such that said plurality of PE are divided into M groups of PE, and each group has N PE, x represents the x^{th} group of PE, y represents the y^{th} PE of the group PE, said inputting step comprising
inputting a plurality of input vectors aᵢ to said M groups of PE,
inputting a fraction Wₚ of said matrix W to the j^{th} PE of each group of PE, wherein j=0,1, . . . N-1,
performing calculations on the received input vector and the received fraction Wₚ of the matrix W by each of said PEs,
outputting the sum of said calculation results to output a plurality of output vectors b₀, b₁, . . . .

12. The method of claim 11, the step of inputting M input vectors aᵢ to said M groups of PE comprising:
choosing i as follows: i (MOD M)=0,1, . . . M-1.

13. The method of claim 11, the step of inputting a fraction Wₚ of said matrix W to the j^{th} PE of each group of PE, wherein j=0,1, . . . N-1, further comprising:
choosing p^{th} rows of W as Wₚ in the following manner: p (MOD N)=j, wherein p =0,1, . . . P-1, j=0,1, . . . N-1, said matrix W is of the size P*Q.

14. The method of claim 11, further comprising: compressing the matrix W with CCS (compressed column storage) or CRS (compressed row storage) format.

15. The method of claim 11, further comprising: encoding said matrix W with an index and codebook.

16. The method of claim 14, said sparse matrix reading step further comprising:
a pointer reading step of reading address information in order to access non-zero weights of said matrix W.

17. The method of claim 15, said sparse matrix reading step further comprising:
a decoding step for decoding the encoded matrix W so as to obtain non-zero weights of said matrix W.

18. The method of claim 11, further comprising:
a leading zero detecting step for detecting non-zero values in input vectors and outputting said non-zero values to the receiving step.

19. The method of claim 11, wherein said step of inputting input vectors further comprising:
using a plurality of FIFO (first in first out) units to input a plurality of input vectors to said groups of PE.

20. The method of claim 11, said outputting step further comprising:
using a first buffer and a second buffer to receive and output calculation results of said PE in an alternative manner, so that one of the buffers receives the present calculation result while the other of the buffers outputs the previous calculation result.
